(19) United States
(12) Patent Application Publication
(10) Pub. No.: US 2005/0280969 A1
(43) Pub. Date: Dec. 22, 2005

(54) Current protection apparatus and method

(75) Inventor: Gregory A. Reynolds, Saratoga, CA (US)

Correspondence Address: Walker & Sako, LLP, Suite 235, 300 South First Street, San Jose, CA, 95113, US

(73) Assignee: Cyber Switching, Inc., San Jose, CA (US)

(21) Appl. No.: 10/870,621

(22) Filed: Jun. 16, 2004

(51) Int. Cl. H02H 3/08

(52) U.S. Cl. 361/93.1

(57) ABSTRACT

A current protection apparatus (200) and current protection method (1000) that may include programmable current protection characteristics has been disclosed. A current protection apparatus (200) may include a power distribution unit (230) with power distribution outlets (PDO-1 to PDO-8), each having a corresponding circuit breaker unit (CB1 to CB8). Each circuit breaker unit (CB1 to CB8) may operate in response to a processing unit (236) that can sample current values flowing between a respective power distribution outlet (PDO-1 to PDO-8) and a load device (LD1 to LD8). Processing unit 236 may operate under control of software stored on a memory (238) to control a switching circuit (320). Current protection characteristics for each circuit breaker unit may be independently programmed and/or altered by a user, for example by way of a computer (250). In this way, each power distribution outlet (PDO-1 to PDO-8) may have current rating characteristics independently provided for a particular load device (LD1 to LD8).

### TECHNICAL FIELD

The present invention relates generally to a current protection apparatus and more particularly to a current protection apparatus including a programmable characteristic and current protection method.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND OF THE INVENTION

A power distribution unit (PDU) can be used to provide power management to a plurality of devices. Referring now to FIG. 1, a block schematic diagram of an apparatus including a conventional PDU for power management to a plurality of devices is set forth and given the general reference character 100.

Apparatus 100 includes a conventional PDU 130 that is connected to a wall outlet 110 through a power cord 120 at inlet 132. Wall outlet 110 can be connected to a 120 Volt Alternating Current (120 VAC) as a power supply voltage, as but one example. Conventional PDU 130 includes eight power distribution outlets (PDO-1 to PDO-8). Each power distribution outlet (PDO-1 to PDO-8) can be connected to a respective load device (LD1 to LD8) through a respective power cord (PC-1 to PC-8).

Conventional PDU 130 also includes a circuit breaker 134. Circuit breaker 134 is connected between the inlet 132 and the power distribution outlets (PDO-1 to PDO-8). In this way, the sum of the currents flowing from each power distribution outlet (PDO-1 to PDO-8) to the respective load device (LD1 to LD8) flows through circuit breaker 134.

Circuit breaker 134 “trips” or becomes an open circuit when the current exceeds the overcurrent rating of the circuit breaker 134. When the circuit breaker 134 trips, the power supply voltage is disconnected from all of the power distribution outlets (PDO-1 to PDO-8) and all of the respective load devices (LD1 to LD8). In this way, even if, for example, load device LD3 is causing the overcurrent condition, all of the other load devices (LD1, LD2 and LD4 to LD8) also are disconnected from the power supply voltage.

Conventional PDU 130 has various drawbacks. For example, in the above-mentioned situation load device LD3 may not be a system critical device. However, load device LD4 may be system critical. In this case, a system critical load device LD4, such as a network server for example, is disconnected from the power supply when a less critical device is causing the overcurrent condition.

Another drawback for conventional PDU 130 is where one of the load devices, for example load device LD5, needs protection at a current lower than the overcurrent rating of circuit breaker 134. For example, load device LD5 could be connected to power distribution outlet PDO-5 with a power cord that is rated to only 5 amps, but circuit breaker 134 can have an overcurrent rating of 15 amps. In this case, load device LD5 may have a current exceeding 5 amps without causing circuit breaker 134 to trip if the other load devices (LD1 to LD4 or LD6 to LD8) collectively draw less than 10 amps. Of course, in the case where only load device LD5 is connected to conventional power distribution unit 130, load device LD5 would not have sufficient overcurrent protection under any condition.

Another drawback for conventional PDU 130 occurs when there is a temporary current surge in one of the load devices (LD1 to LD8). In this case, circuit breaker 134 can trip even though the current surge will not cause an electrical failure to the offending load device (LD1 to LD8). As previously mentioned, when circuit breaker 134 trips, all the load devices (LD1 to LD8) lose power.

In view of the above discussion, it would be desirable to provide a current protection apparatus that may provide individual and/or customized current protection to a load device.

It would also be desirable to provide a method of current protection that may provide individual and/or customized current protection to a load device.

It would also be desirable to provide a current protection apparatus and method of current protection that may provide protection from current surges that may damage an individual load device without unwarranted protection against a temporary current surge that may not be sufficient to cause an electrical failure of a load device. It would further be desirable to provide such protection in a power distribution unit.

It would also be desirable to provide a current protection apparatus and method of current protection for a power distribution unit that may provide individual and customized current protection to each load device connected to a power distribution outlet.

Additionally, a method, system, and apparatus for remote power management and monitoring has been set forth in commonly owned and co-pending U.S. patent application Ser. No. 10/625,837 filed Jul. 22, 2003, U.S. patent application Ser. No. 10/431,333 filed May 6, 2003, U.S. Provisional Patent Application Ser. No. 60/378,342 filed May 6, 2002, Canadian Patent Application Number 2,428,285 filed May 6, 2003, and European Patent Application Number 03252833.3 filed May 6, 2003. The full disclosures of these patent applications are incorporated by reference.

### SUMMARY OF THE INVENTION

According to the present embodiments, a current protection apparatus and current protection method that may include programmable current protection characteristics is disclosed. A current protection apparatus may include a power distribution unit. A power distribution unit may include power distribution outlets, each having a corresponding circuit breaker unit. Each circuit breaker unit may operate in response to a processing unit to sample current values corresponding to a current flowing between a respective power distribution outlet and a load device. A processing unit may operate under control of software stored in a memory to control a switching circuit. Current protection characteristics for each circuit breaker unit may be independently programmed and/or altered by a user, for example by way of a computer. In this way, each power distribution outlet may have current rating characteristics independently provided for a particular load device.

According to one aspect of the embodiments, a current protection method may include the steps of sampling a current value of a current flowing from a power source to a load device for at least one current characteristic and interrupting the current flowing from the power source to the load device according to a comparison between the at least one current characteristic and at least one programmable limit.

According to another aspect of the embodiments, the at least one programmable limit may be a predetermined current limit value.

According to another aspect of the embodiments, the at least one programmable limit may include a predetermined time period and the current value may exceed a predetermined current limit value for essentially a predetermined time period.

According to another aspect of the embodiments, the step of sampling a current value of a current flowing from a power source to a load device for at least one current characteristic may be repeated a plurality of times during a predetermined time period.

According to another aspect of the embodiments, the step of sampling a current value may include taking current readings of the current flowing from the power source to the load device and performing parametric calculations to provide the current value.

According to another aspect of the embodiments, parametric calculations may include peak current root mean square current, and crest factor harmonic current.

According to another aspect of the embodiments, a current protection method may include the steps of sampling a first current value of a first current flowing from a first power distribution outlet to a first load device and a second current value of a second current flowing from a second power distribution outlet to a second load device, comparing the first current value with a first predetermined current limit value and a second current value with a second predetermined current limit value, and interrupting the first current flowing from the first power distribution outlet to the first load device in response to the first current value exceeding the first predetermined current limit value and interrupting the second current flowing from the second power distribution outlet to the second load device in response to the second current value exceeding the second predetermined current limit value.

According to another aspect of the embodiments, the first predetermined current limit value and the second predetermined current limit value are programmable.

According to another aspect of the embodiments, the step of comparing the first current value with a first predetermined current value and the second current value with a second predetermined current limit value may be performed with software.

According to another aspect of the embodiments, when the step of comparing the first current value results in the first current value exceeding the first predetermined current limit value, repeating the step of sampling the first current value and the step of comparing the first current value with the first predetermined current limit value after a first predetermined time period. When the step of comparing the second current value results in the second current value exceeding the second predetermined current limit value, repeating the step of sampling the second current value and the step of comparing the second current value with the second predetermined current limit value after a second predetermined time period. The first current flowing from the first power distribution outlet is interrupted only when the second step of comparing results in the first current value exceeding the first predetermined current limit value and the second current flowing from the second power distribution outlet is interrupted only when the second step of comparing results in the second current value exceeding the second predetermined current limit value.

According to another aspect of the embodiments, the first predetermined time period and the second predetermined time period may be the same.

According to another aspect of the embodiments, the first predetermined time period and the second predetermined time period may be different.

According to another aspect of the embodiments, the step of comparing the first current value with the first predetermined current limit value after the first predetermined time period and the step of sampling the second current value and the step of comparing the second current value with the second predetermined current limit value after the second predetermined time period may be performed with software.

According to another aspect of the embodiments, a current protection method for a power distribution unit may include the steps of sampling a plurality of current values for a plurality of currents, each of the plurality of currents comprising a current flowing between one of a plurality of power distribution outlets and a corresponding load device, comparing each of the plurality of current values with a corresponding one of a plurality of predetermined current limit values, and interrupting the current flowing between the corresponding power distribution outlet and the corresponding load device if the corresponding current value is greater than the corresponding predetermined current limit value.

According to another aspect of the embodiments, each of the plurality of predetermined current limit values may be programmable.

According to another aspect of the embodiments, the step of comparing each of the plurality of current values with the corresponding one of the plurality of predetermined current limit values may be performed with software.

According to another aspect of the embodiments, a current protection computer program embodied on a computer readable media may include: a reading code portion, for reading a plurality of current values for a plurality of currents, each of the plurality of currents comprising a current flowing between one of a plurality of power distribution outlets and a corresponding load device; and a comparing code portion, for comparing each of the plurality of current values with a corresponding one of a plurality of predetermined current limit values and providing an interrupt command for interrupting the current flowing between the corresponding power distribution outlet and the corresponding load device if the corresponding current value is greater than the corresponding predetermined current limit value.

According to another aspect of the embodiments, the reading code portion may read the plurality of current values during a predetermined time period and the comparing code portion may provide the interrupt command if the corresponding current value is greater than the corresponding predetermined current value for essentially the predetermined time period.

According to another aspect of the embodiments, a current protection apparatus may include a current sampling circuit, a processing unit, and a switching circuit. The current sampling circuit may sample a first current value of a current flowing from a power source to a first load device. A processing unit may receive the first current value and may be controlled by a software program to compare the first current value with a predetermined current limit value to generate a first compare result. A switching circuit may be coupled between the power source and the first load device. The switching device may interrupt the current flowing from the power source to the load device in response to at least the first compare result indicating that the first current value may exceed the predetermined current limit value.

According to another aspect of the embodiments, the current sampling circuit may sample a second current value of the current flowing from the power source to the first load device a first predetermined time period after the first current value is sampled. The processing unit may receive the second current value and may be controlled by the software program to compare the second current value with the predetermined current limit value to generate a second compare result. The switching circuit may interrupt the current flowing from the power source to the load device in response to the second compare result indicating that the second current value exceeds the predetermined current limit value.

According to another aspect of the embodiments, the current sampling circuit may sample a plurality of intermediate current values of the current flowing from the power source to the first load device during the first predetermined time period after the first current value is sampled. The processing unit may receive the plurality of intermediate current values and may be controlled by the software program to compare the plurality of intermediate current values with the predetermined current limit value to generate a plurality of intermediate compare results. The switching circuit may interrupt the current flowing form the power source to the load device in response to the plurality of intermediate compare results indicating each of the plurality of intermediate current values exceeds the predetermined current limit value and to the second compare result indicating that the second current value exceeds the predetermined current limit value.

According to another aspect of the embodiments, the current sampling circuit may include an analog to digital converter.

According to another aspect of the embodiments, the switching circuit may include a mechanical relay or a solid state relay.

According to another aspect of the embodiments, the current sampling circuit may include a current sensing circuit, such as an isolation step down transformer, a Hall effect device, a sense resistor, or a magnetometer.

According to another aspect of the embodiments, a current protection apparatus for a power distribution unit may include a current sampling circuit, a processing unit, a first switching circuit, and a second switching circuit. A current sampling circuit may sample a first current value of a first current flowing from a first power distribution outlet and a first load device and a second current flowing from a second power distribution outlet and a second load device. A processing unit may receive the first current value and the second current value. The processing unit may be controlled by a software program to compare the first current value with a first predetermined current limit value to generate a first comparison result and compare a second current value with a second predetermined current limit value to generate a second comparison result. The first switching circuit may be coupled between the first power distribution outlet and the first load device. The first switching circuit may interrupt the first current flowing from the first power distribution outlet to the first load device in response to at least the first compare result indicating that the first current value exceeds the first predetermined current limit value. The second switching circuit may be coupled between the second power distribution outlet and the second load device. The second switching circuit may interrupt the second current flowing from the second power distribution outlet to the second load device in response to at least the second compare result indicating that the second current value exceeds the second predetermined current limit value.

According to another aspect of the embodiments, the current sampling circuit may sample a third current value of the current flowing from the first power distribution outlet to the first load device a first predetermined time period after the first current value is sampled when the first current value exceeds the first predetermined current limit value and may sample a fourth current value of the current flowing from the second power distribution outlet to the second load device a second predetermined time period after the second current value is sampled when the second current value exceeds the second predetermined current limit value. The processing unit may receive the third current value if the first current value exceeds the first predetermined current limit value and may be controlled by the software program to compare the third current value with the first predetermined current limit value to generate a third comparison result and may receive the fourth current value if the second current value exceeds the second predetermined current limit value and may be controlled by the software program to compare the fourth current value with the second predetermined current limit value to generate a fourth comparison result. The first switching circuit may interrupt the first current flowing from the first power distribution outlet to the first load device in response to the third compare result indicating that the third current value exceeds the first predetermined current limit value. The second switching circuit may interrupt the second current flowing from the second power distribution outlet to the second load device in response to the fourth compare result indicating that the fourth current value exceeds the second predetermined current limit value.

According to another aspect of the embodiments, the power distribution unit may include the first power distribution outlet and the second power distribution outlet.

According to another aspect of the embodiments, a current protection apparatus for a power distribution unit may include a current sampling circuit, a processing unit, and a plurality of switching circuits. The current sampling circuit may sample a plurality of first current values, each first current value corresponding to a current flowing from one of a plurality of power distribution outlets to a corresponding one of a plurality of load devices. The processing unit may receive the plurality of first current values and may be controlled by a software program to compare each of the plurality of first current values with a corresponding one of a plurality of predetermined current limit values to generate a plurality of first compare results. Each one of the plurality of switching circuits may be coupled between one of the plurality of power distribution outlets and a corresponding one of the plurality of load devices. Each one of the plurality of switching devices may interrupt the corresponding one of the plurality of currents flowing between one of the plurality of power distribution outlets and the corresponding one of the plurality of load devices in response to at least the corresponding one of the plurality of first compare results indicating that the corresponding one of the plurality of first current values is greater than the corresponding one of the plurality of predetermined current limit values.

According to another aspect of the embodiments, when the corresponding one of the plurality of compare results indicates that the corresponding one of the plurality of current values is greater than the corresponding one of the plurality of current values, the current sampling circuit may sample at least a second current value corresponding to the current flowing from the one of the plurality of power distribution outlets to the corresponding one of the plurality of load devices a predetermined time period after the sampling of the corresponding first current value. The processing unit may be coupled to receive the at least second current value and may be controlled by the software program to compare the at least second current value with the corresponding one of a plurality of predetermined current limit values to generate a second compare result. The corresponding one of the plurality of switching devices may interrupt the corresponding one of the plurality of currents flowing between one of the plurality of power distribution outlets and the corresponding one of the plurality of load devices in response to at least the second compare result indicating that the second current value is greater than the corresponding one of the plurality of predetermined current limit values.

According to another aspect of the embodiments, the power distribution unit may include the plurality of power distribution outlets, the current sampling circuit, the processing unit, and the plurality of switching circuits.

### BRIEF DESCRIPTION OF THE DRAWINGS

FIG. 1 is a block schematic diagram of an apparatus including a conventional power distribution unit (PDU) for power management of a plurality of devices.

FIG. 2 is a block schematic diagram of a power distribution apparatus according to an embodiment.

FIG. 3 is a circuit schematic diagram of selected portions of a power distribution unit according to an embodiment.

FIG. 4 is a user interface for inputting programmable values for a power distribution unit according to an embodiment.

FIG. 5 is a user interface for monitoring a power distribution unit according to an embodiment.

FIG. 6 is a timing diagram showing a first mode of operation for embodiments of the present invention.

FIG. 7 is a timing diagram showing a second mode of operation for embodiments of the present invention.

FIG. 8 is a timing diagram showing a third mode of operation for embodiments of the present invention.

FIG. 9 is a flow diagram of a method according to one embodiment of the present invention.

FIG. 10 is a flow diagram of a method according to another embodiment of the present invention.

### DETAILED DESCRIPTION OF THE EMBODIMENTS

Various embodiments of the present invention will now be described in detail with reference to a number of drawings.

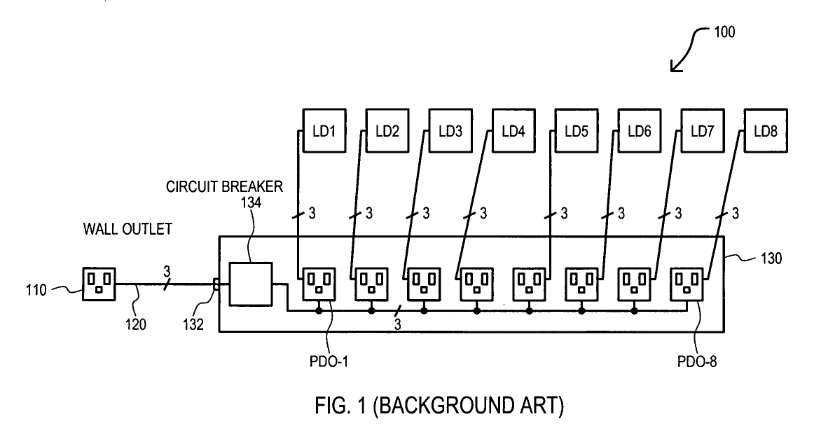

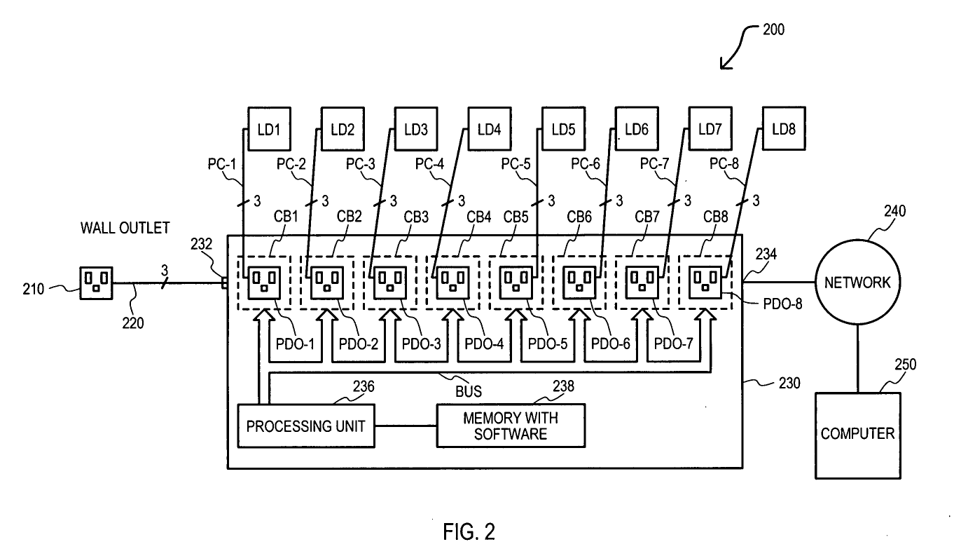

Referring now to FIG. 2, a block schematic diagram of a power distribution apparatus according to an embodiment is set forth and given the general reference character 200. Apparatus 200 may include similar constituents as apparatus 100 of FIG. 1 and such constituents may be referred to by the same reference character.

Apparatus 200 may include a wall outlet 210, a power cord 220, a power distribution unit 230, load devices (LD1 to LD8), a network 240, and a computer 250.

Power cord 220 may provide an electrical connection between wall outlet 210 and an input terminal 232 of power distribution unit 230. Power distribution unit 230 may include a port 234 connected to network 240. Computer 250 may optionally be connected to network 240. Each load device (LD1 to LD8) may be connected to a respective power distribution outlet (PDO-1 to PDO-8) through a respective power cord (PC-1 to PC-8).

Power distribution unit 230 may include a processing unit 236 and a memory 238. Each power distribution outlet (PDO-1 to PDO-8) may have a respective circuit breaker unit (CB1 to CB8) associated therewith. Processing unit 236 may be connected to each circuit breaker unit (CB1 to CB8) by way of a bus BUS.

The operation of the power distribution apparatus 200 will now be discussed.

Each circuit breaker unit (CB1 to CB8) may be independently set to trip at an independent current value. A user may set the independent current value for each circuit breaker unit (CB1 to CB8) at computer 250. These values may be transferred through network 240 to port 234 of PDU 230. Processing unit 236 may operate under the control of software stored in memory 238 to sample current flowing through each circuit breaker unit (CB1 to CB8) by sending instructions and receiving current data values along bus BUS. In this way, the current flowing between each power distribution outlet (PDO-1 to PDO-8) and each respective load device (LD1 to LD8) may be monitored.

Processing unit 236 may sample the current data values and capture a digital version of a current waveform of the current flowing through each circuit breaker unit (CB1 to CB8). Processing unit 236 may then perform parametric calculations on each waveform to provide the current values to be used in a comparison step. In the comparison step, processing unit 236 may determine if the current value is greater than the previously programmed independent current value. If any of the comparisons show the sampled current value is greater, then a trip command may be sent to the circuit breaker unit (CB1 to CB8) having the overcurrent condition. The trip command may instruct the circuit breaker unit (CB1 to CB8) to trip. In this way, each power distribution outlet (PDO-1 to PDO-8) may have an independently programmed current value (e.g., circuit breaker current rating). These independently programmed current values may be changed by a user through a software interface at computer 250 at essentially any time.

The above-mentioned parametric calculation performed by processing unit 236 on each current waveform may include peak current, root-mean-square (RMS) current, and crest factor harmonic current, as just a few examples.

In the above-mentioned operation, an overcurrent protection value may be independently programmed for each power distribution outlet. In this case, the independently programmed current values may be set to protect load devices (LD1 to LD8) from current spikes, which may cause hardware damage. However, it may also be desirable to provide protection against current magnitudes that may only cause damage or adverse effects if a current magnitude is sustained for a predetermined time period. Such a feature of the embodiment of FIG. 2 will now be described in detail.

Each circuit breaker unit (CB1 to CB8) may be independently set to trip at an independent sustained current value over an independent time period. A user may set the independent sustained current value and independent time period for each circuit breaker unit (CB1 to CB8) at computer 250. These values may be transferred through network 240 to port 234 of PDU 230. Processing unit 236 may operate under the control of software stored in memory 238 to sample current flowing through each circuit breaker unit (CB1 to CB8) by sending instructions and receiving current data values along bus BUS. In this way, the current flowing between each power distribution outlet (PDO-1 to PDO-8) and each respective load device (LD1 to LD8) may be monitored.

Processing unit 236 may sample the current data values and capture a digital version of a current waveform of the current flowing through each circuit breaker unit (CB1 to CB8). Processing unit 236 may then perform parametric calculations on each waveform to provide the current values to be used in a comparison step. In the comparison step, processing unit 236 may determine if the current value is greater than the previously programmed independent sustained current value. If any of the comparisons show the sampled current value is greater, then processing unit 236 may re-sample the current data value of the circuit breaker unit (CB1 to CB8) having the initial overcurrent condition after the independent time period for that circuit breaker unit (CB1 to CB8) has elapsed.

Then, processing unit 236 may capture a second digital version of a current waveform of the current flowing through the circuit breaker unit (CB1 to CB8) having the initial overcurrent condition. Processing unit 236 can perform a second parametric calculation on a second captured waveform to provide a current value to be used in a second comparison step. In the second comparison step, processing unit 236 may determine if the current value is greater than the previously programmed independent sustained current value. If the comparison shows the sampled current value is still greater, then a trip command may be sent to the circuit breaker unit (CB1 to CB8) having the sustained overcurrent condition. The trip command may instruct the circuit breaker unit (CB1 to CB8) to trip.

In this way, each power distribution outlet (PDO-1 to PDO-8) may have an independently programmed protection against current magnitudes that may only cause damage or adverse affects if a current magnitude is sustained for a predetermined time period. The sustained current magnitudes and predetermined time periods may be independently programmed for each power distribution outlet (PDO-1 to PDO-8). Alternately, a time period that is the same for all the power distribution outlets (PDO-1 to PDO-8) or a subset of power distribution outlets (PDO-1 to PDO-8) may be set or used as an initial default. These independently programmed current values and time periods may be changed by a user through a software interface at computer 250 at any time.

The above-mentioned parametric calculation performed by processing unit 236 on each current waveform may include peak current, root-mean-square (RMS) current, and crest factor harmonic current, as just a few examples.

In the above-mentioned operation, the current values for each power distribution outlet (PDO-1 to PDO-8) are sampled. If an initial comparison shows that there is a potential sustained overcurrent condition, another sample is taken after a predetermined time period has elapsed. However, it may be desirable to continuously sample the current value after the initial sample has indicated the potential sustained overcurrent condition. In this case, the command for the circuit breaker unit (CB1 to CB8) to trip may only be executed if all of the plurality of samples during the predetermined time period indicate the continuous overcurrent condition in the comparison step. In this way, dips below the continuous overcurrent condition may reset the algorithm back to the initial sample and comparison steps.

In yet another feature of the embodiment of FIG. 2, a user may independently set a time percentage of overcurrent condition in a predetermined time period. In this way, sampling and comparison steps may be performed as in the above-mentioned continuous overcurrent condition check. However, the trip command to the circuit breaker unit (CB1 to CB8) may only be executed if the overcurrent condition has occurred over a predetermined percentage of a predetermined time period.

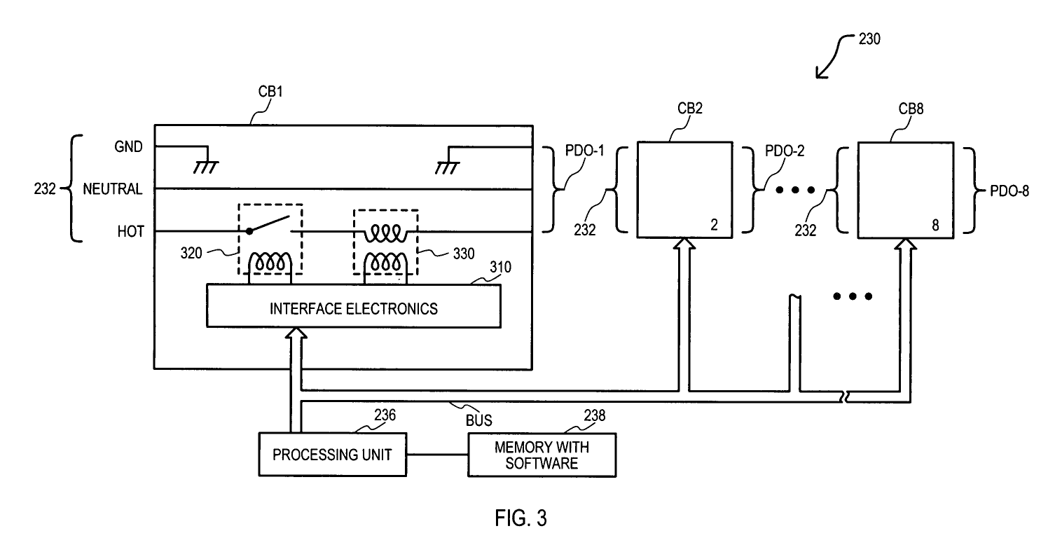

Referring now to FIG. 3, a circuit schematic diagram of selected portions of power distribution unit 230 according to an embodiment are set forth.

FIG. 3 illustrates a circuit breaker unit (CB1 to CB8) in detail. Only the details of circuit breaker unit CB1 are illustrated in order to avoid unduly cluttering up the figure. However, circuit breaker units (CB2 to CB8) may include essentially the same constituents.

Circuit breaker unit CB1 may include a switching circuit 320, a current sampling circuit 330, and interface electronics 310. Circuit breaker unit CB1 may receive an input voltage from input terminal 232 and may provide an output voltage at power distribution outlet PDO-1. In this case, a 120 VAC may be received including a ground GND, neutral NEUTRAL and hot HOT.

Ground GND may be connected to a base of power distribution unit 230, as one example. Neutral NEUTRAL may pass directly through to power distribution outlet PDO-1. Switching circuit 320 and current sampling circuit 330 may be provided in series between the input terminal 232 and power distribution outlet PDO-1 in the hot HOT signal path.

Interface electronics 310 may provide control for switching circuit 320 and may sample current values provided by current sampling circuit 330. Interface electronics 310 may receive current values provided by current sampling circuit 330 in an analog form and may include an analog to digital converter (not shown) to provide digital current values. According to control signals from interface electronics 310 a switching circuit 320 may be opened to interrupt current flowing between power distribution outlet PDO-1 and load device LD1 connected thereto (illustrated in FIG. 2). In a similar fashion, interface electronics 310 may provide control for closing switching circuit 320 to allow current to flow between power distribution outlet PDO-1 and load device LD1 connected thereto (illustrated in FIG. 2).

Switching circuit 330 may include a mechanical relay or a solid-state relay, such as a thyristor, as just two examples. Current sampling circuit 330 may include an isolation step down transformer, a Hall effect device, a sense resistor or a magnetometer, as just a few examples.

Processing unit 236 may provide commands to interface electronics 310 based on an algorithm and programmed values (set as indicated above in the operation of the embodiment of FIG. 2), which may be stored in memory 238.

It is noted that each circuit breaker unit (CB1 to CB8) may commonly receive an input voltage from input terminal 232 and may provide an output voltage at a respective power distribution outlet (PDO-1 to PDO-8).

Memory 238 may be included on processing unit 236 or may be a separate integrated circuit, as just one example.

It is also noted that a PDU 230 may also provide additional current readings beyond those of individual power distribution outlets (PDO-1 to PDO-8). In particular, a PDU 230 may logically divide power distribution outlets (PDO-1 to PDO-8) into two or more banks. A current value for each such bank can be generated and monitored in the same general fashion as a power distribution outlet, as described above. As but one very particular example, a bank current value may be generated by summing current values of the respective power distribution outlets of the bank, or by an in-line monitoring structure (e.g., step-down transformer) assuming separate power line wiring for each bank.

In addition, in alternate embodiments, circuit breaker trip actions can be provided on a bank-by-bank basis. As but one example, individual circuit breakers for all power distribution outlets of a bank can be tripped essentially simultaneously in the event of a bank overcurrent condition. Alternatively, assuming separate power line wiring for each bank, a bank circuit breaker can be employed. Of course, limits for bank current values may also be programmable.

Along these same lines, a PDU 230 can provide an overall unit current reading for the PDU 230. As but one very particular example, a unit current value may be generated by summing currents to all of the power distribution outlets of the PDU 230, or by an in-line monitoring structure. Current limits for a PDU 230 can be programmable.

It follows that in alternate embodiments, circuit breaker trip actions can be provided for the PDU 230. As but one example, individual circuit breakers for all power distribution outlets of PDU 230 can be tripped essentially simultaneously in the event of a unit overcurrent condition. Alternatively, a unit circuit breaker can be employed.

In this way, warnings and/or circuit breaker trip actions can occur not only on an outlet-by-outlet basis, but also on a bank-by-bank and/or overall unit basis.

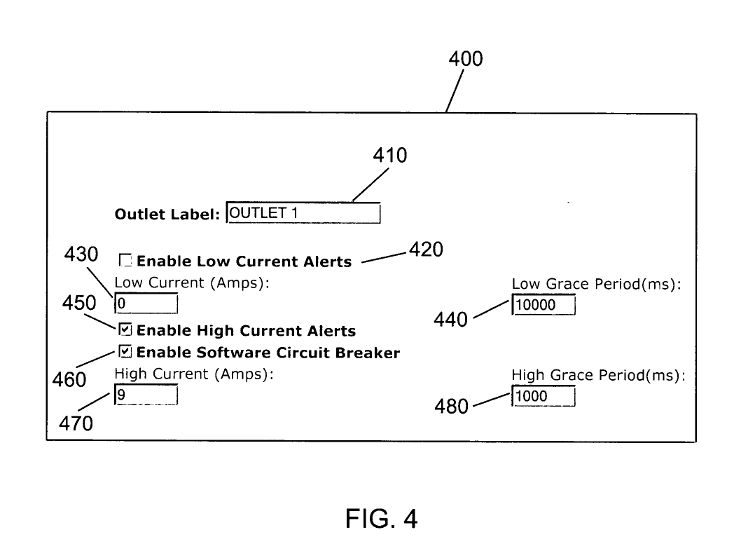

Referring now to FIG. 4, a user interface for inputting programmable values for the power distribution unit 230, such as that shown in FIG. 2 is set forth and given the general reference character 400. User interface 400 may be a user interface on computer 250 of FIG. 2, for example.

Referring now to FIG. 4 in conjunction with FIG. 2, user interface 400 may include input boxes (410 to 480). Input box 410 may be used to select one of the power distribution outlets (PDO-1 to PDO-8). Once the power distribution outlet (PDO-1 to PDO-8) is selected, input boxes (420 to 480) may be input with values or selected with, for example a mouse click, to enable or disable features for the selected power distribution outlet (PDO-1 to PDO-8) identified in input box 410.

Input box 420 may be used to enable low current alerts. A low current alert may be used to notify a user when a current for a predetermined power distribution outlet (PDO-1 to PDO-8) has remained below a low current value for longer than a low grace period. Input box 430 may be used to provide the low current value and input box 440 may be used to provide the low grace period. In this case, processing unit 236 may monitor current flowing through the selected circuit breaker unit (CB1 to CB8) by sending instructions and receiving current data values along bus BUS. In this way, the current flowing between the selected power distribution outlet (PDO-1 to PDO-8) and a respective load device (LD1 to LD8) may be monitored. If the current flowing through the selected circuit breaker unit (CB1 to CB8) remains below the low current value as indicated by input box 430 for longer than a low grace period as indicated by input box 440, a user may be notified. A user may be notified by a pop-up window alert on computer 250, as just one example.

Input box 450 may be used to enable high current alerts and input box 460 may be used to enable the circuit breaker functions as described above with respect to FIGS. 2 and 3. A high current alert may be used to notify a user when a current for a predetermined power distribution outlet (PDO-1 to PDO-8) has remained above a high current value for longer than a high grace period. Input box 470 may be used to provide the high current value and input box 480 may be used to provide the high grace period. The high current value provided in input box 470 may correspond to a sustained current value as described above in the embodiment of FIG. 2. The high grace period provided in input box 480 may correspond to the time period for the sustained current value as described above in the embodiment of FIG. 2.

Other input boxes may be provided in the user interface 400. For example, an overcurrent protection value may be provided in an input box. In this way, each power distribution outlet (PDO-1 to PDO-8) may be protected against currents that may be instantaneously destructive to a load device (LD1 to LD8) as described above with respect to the embodiment of FIG. 2. In this case, an overcurrent protection value may be provided which may be just below a destructive value in order to provide adequate protection margin for the load device (LD1 to LD8).

Yet other input boxes may be provided for the user interface 400. For example, a time percentage input box may be provided to enable protection against a time percentage of overcurrent condition for a predetermined time period.

Each circuit breaker operating mode, destructive overcurrent, time period overcurrent, or the like, may include input boxes for enabling or disabling the operating mode as well as providing alerts to the user.

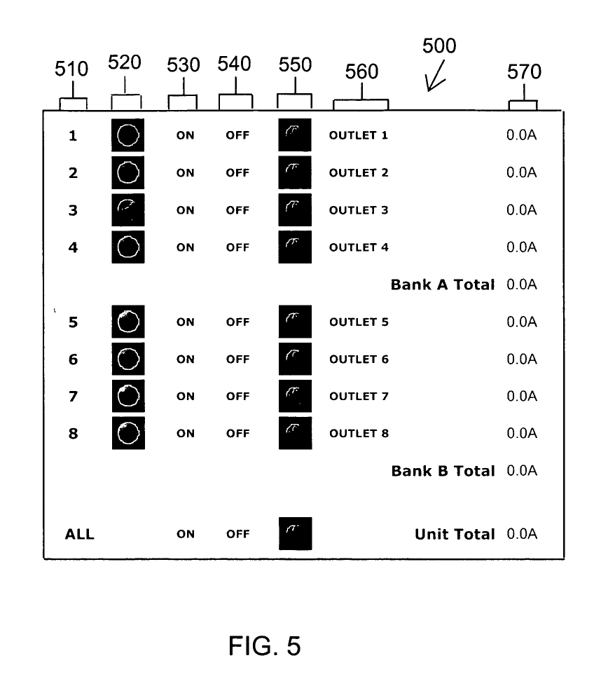

In FIG. 5, a user interface for monitoring the power distribution unit 230 of FIG. 2 is set forth and given the general reference character 500. User interface 500 may be a user interface on computer 250 of FIG. 2, for example.

Referring now to FIG. 5 in conjunction with FIG. 2, user interface 500 may include columns (510 to 570) of user information and icons for enabling functions.

Column 510 may include numbers for identifying the location of the power distribution outlet (PDO-1 to PDO-8) that the user information and icons on the row may correspond.

Column 520 may include an icon for identifying whether or not the corresponding power distribution outlet (PDO-1 to PDO-8) is on, off, or tripped, as just a few examples. The icons of column 520 may have a different color to indicate a condition of the power distribution outlet (PDO-1 to PDO-8). For example, green may indicate “on”, black may indicate “off”, and red may indicate “tripped”.

Column 530 may include an icon for manually turning on a corresponding power distribution outlet (PDO-1 to PDO-8). Column 540 may include an icon for manually turning off a corresponding power distribution outlet (PDO-1 to PDO-8). When a power distribution outlet (PDO-1 to PDO-8) is in a “tripped” condition, it may be required to mouse click on the “OFF” icon before mouse clicking on the “ON” icon to reset the switching circuit 330 so that the power distribution outlet (PDO-1 to PDO-8) is reset to “on”.

Column 550 may include a clock icon. By mouse clicking on the clock icon, a window may be open that can allow you to program a time schedule for the corresponding power distribution outlet (PDO-1 to PDO-8). A time schedule may include turning on and turning off selected power distribution outlets (PDO-1 to PDO-8) at predetermined time periods in a day.

Column 560 may include a name for a corresponding power distribution outlet (PDO-1 to PDO-8). The name may be, for example, the name of the load device (LD1 to LD8), such as printer, server, router, as just a few examples. In this way, the user may more conveniently identify the load device (LD1 to LD8) for which the user information and icons for enabling functions may correspond.

Column 570 may include values of current flowing through each circuit breaker unit (CB1 to CB8), which can correspond to current flowing between each power distribution outlet (PDO-1 to PDO-8) and respective load device (LD1 to LD8).

It is understood that although “mouse clicking” has been used as an example for selecting features on the user interfaces (400 and 500) any input device may be used, for example, a keyboard, a touch screen pointer, or the like.

Although the user interface of FIG. 5 illustrates a status of power distribution outlets (PDO-1 to PDO-8) in a graphical form, simple text may be used as well. For example, a “tripped” condition may be indicated with the word “trip” next to the corresponding power distribution outlet (PDO-1 to PDO-8) label.

The embodiment of FIG. 2 may be used in conjunction with other circuit protection. For example, circuit protection for a wall outlet (210) may already be provided at a circuit breaker box. However, with the embodiment of FIG. 2, individual cord connected devices may have customized protection. For example, a breaker box may have a breaker rated at 15 Amps, but with the embodiment of FIG. 2, a load device (LD1 to LD8) may have customized protection of 5 Amps. Such customized protection may be needed, for example, in a computer system or the like.

The apparatus 200 of FIG. 2 may prevent catastrophic current from one load device (LD1 to LD8) from causing a circuit breaker to “trip” and interrupt power to all the load devices as in the prior art. Instead, only the power distribution outlet (PDO-1 to PDO-8) which is providing power to the load device (LD1 to LD8) having the catastrophic current will have power interrupted. This can be desirable in, for example, a series of network devices all plugged into the PDU 230. In this way, only the offending network device will have power interrupted and employee downtime may be reduced or eliminated.

Apparatus 200 may include other advantages. For example, when a hardware upgrade occurs and a newly connected load device (LD1 to LD8) draws a larger current, problems may occur with the conventional approach of FIG. 1. For example, if five load devices (LD1 to LD5) are connected to PDU 230 and each load device draws 3 amps and the outlet is protected at 15 amps. Then, load device LD5 is changed to a load device that draws 5 amps. With apparatus 200, only the newly connected load device LD5 may have power interrupted.

A circuit protection system as in apparatus 200 may be used to protect power supplies. As one example, a plurality of supplies may be used to provide current to a shared load that draws more current than a single supply can provide. By providing a circuit breaker unit (CB1 to CB8) to each power supply, the power supplies may be protected. For example, if one power supply goes bad, all the other power supplies may be protected by programming the programmable current characteristics so that each individual circuit breaker unit (CB1 to CB8) disconnects the power supply from the load if an overcurrent condition exists. In this way, all the power supplies may be protected.

In another case, a PDU may be connected to an outlet that can provide more current than the rating of the PDU. In this case, PDU 230 may be used and it can provide adequate self protection by properly programming the programmable current characteristics.

It is understood that the embodiments described above are exemplary and the present invention should not be limited to those embodiments. Specific structures should not be limited to the described embodiments.

For example, in the embodiment of FIGS. 2 and 3, a power supply of 120 VAC is received at input terminal 232. However, a power supply may be 240 VAC. In this case, two “hot” wires may be used and switching circuit 320 may provide a switch for both “hot” wires. In another example, a DC voltage may be provided. In this case, a switching circuit 320 may only provide a switch to the power supply voltage (VDD). Also, in the case of a DC voltage, parametric calculations may not be necessary for processing unit 236 to perform.

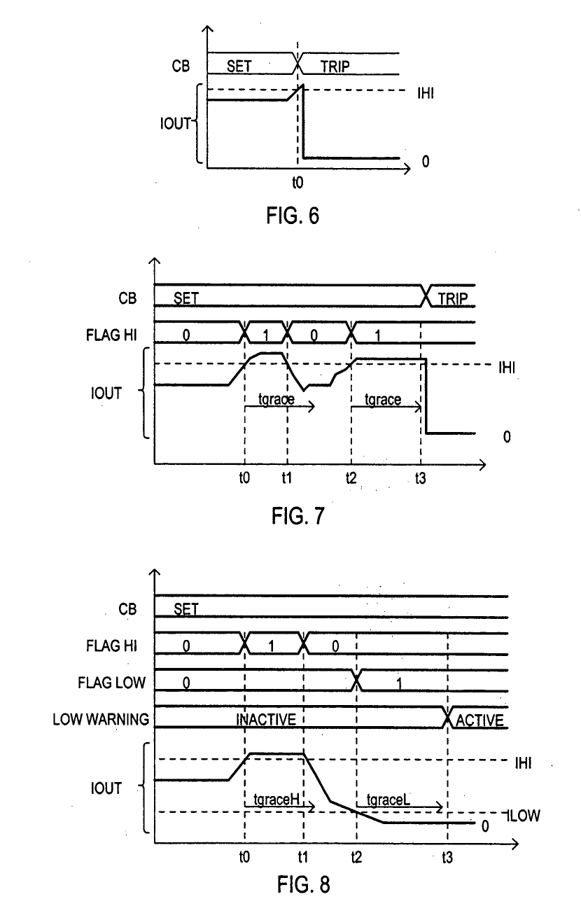

Referring now to FIG. 6, a graph is set forth illustrating one operating mode for embodiments of the invention. FIG. 6 includes a waveform CB that represents the operation of a circuit breaker for an individual outlet or bank of outlets. Waveform IOUT shows a current output from such a circuit breaker. A current value IHI represents a programmed high limit, and is understood to be selectable by a user.

Referring still to FIG. 6, at time t0, current IOUT exceeds a programmed high limit IHI. Such a current value is detected for a given outlet/bank, compared by operation of software to the programmable limit IHI. Because the limit is exceeded, a “trip” value can be generated. As but one example, a processor may write a predetermined byte value to a register that indicates a trip operation. In response to such a value, a switching circuit opens the current path(s) for the outlet/bank.

Referring now to FIG. 7, a graph is set forth illustrating another operating mode for embodiments of the invention. FIG. 7 includes the same general waveforms as FIG. 6. In addition, FIG. 7 also shows a waveform FLAG HI that can represent a flag that indicates when a current value first exceeds a limit. However, unlike the arrangement of FIG. 6, in the operation of FIG. 7 a PDU (e.g., 230) includes a programmable grace period (tgrace). A circuit breaker for an outlet/bank will only be tripped if the current value remains over the limit for the entire grace period.

Referring still to FIG. 7, at time t0, current IOUT exceeds a programmed high limit IHI. As a result, flag value FLAG HI is set (represented by a “1”).

At time t1, current IOUT falls below limit IHI prior to expiration of grace period (tgrace). Consequently, flag value FLAG HI is reset (represented by a return to “0”).

At time t2, current IOUT once again exceeds a programmed high limit IHI. As a result, flag value FLAG HI is once again set (represented by a “1”).

At time t3, current IOUT remains above limit IHI and the grace period has expired (i.e., flag value FLAG HI is still set). As a result, a circuit breaker can be tripped.

Referring now to FIG. 8, a graph is set forth illustrating yet another operating mode for embodiments of the invention. FIG. 8 includes the same general waveforms as FIG. 7. In addition, FIG. 8 also shows a waveform FLAG LOW that can represent a flag indicating when a current value falls below a low current limit (ILOW), and a waveform LOW WARNING that can indicate a warning issued by a PDU. Unlike the arrangement of FIG. 7, in the operation of FIG. 8 a PDU further includes a low programmable grace period (tgraceL). In the very particular example, a circuit breaker for an outlet/bank will provide a warning if the current value remains under the low limit for a low grace period (tgraceL).

Referring still to FIG. 8, at time t0, current IOUT exceeds a programmed high limit IHI. As a result, flag value FLAG HI is set (represented by a “1”).

At time t1, current IOUT falls below high programmed limit IHI. As a result, flag value FLAG HI is reset (represented by a return to “0”).

At time t2, current IOUT falls below low programmed limit ILOW. As a result, flag value FLAG LOW is set (represented by a “1”).

At time t3, current IOUT remains below limit ILOW and the low grace period (tgraceL) has expired (i.e., flag value FLAG LOW is still set). As a result, a low current warning can be issued.

Having described the structure and operation of various embodiments, methods according to the present invention will now be described.

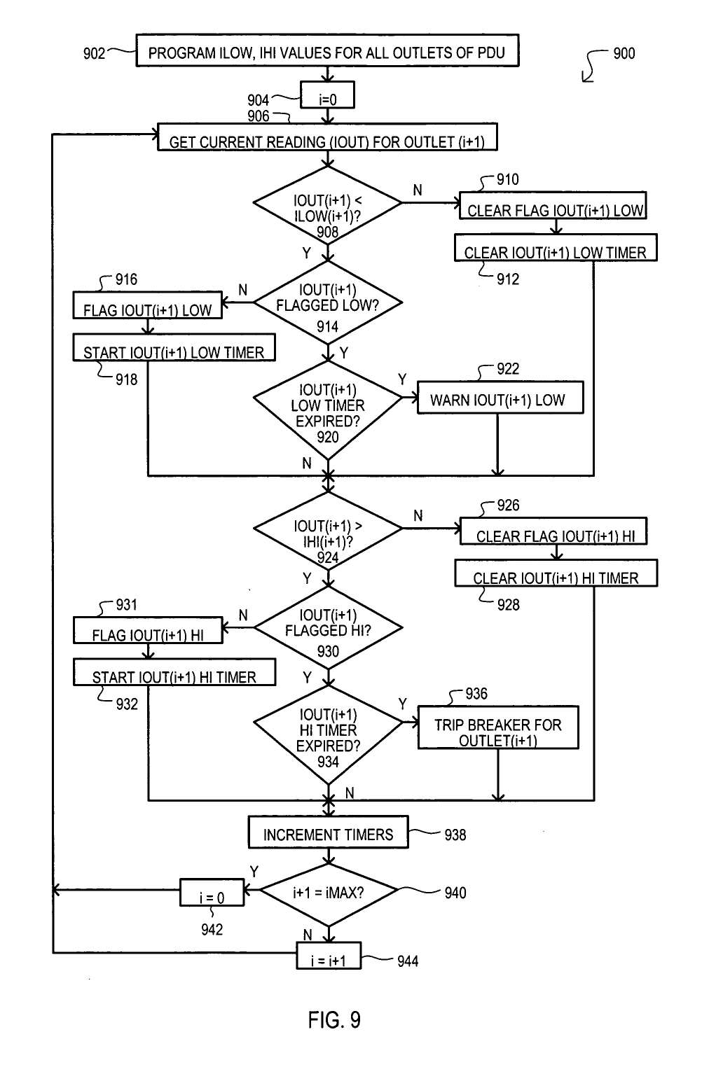

Referring now to FIG. 9, one example of a method according to the present invention is set forth in a flow diagram and designated by the general reference character 900. A method 900 can include programming high and low limits for all power distribution outlets of a PDU (step 902). As but one example, such a method can include programming a PDU by way of an interface, as described above. In the very particular example of FIG. 9, current values for each separate power distribution outlet (referred to herein as “outlet”) may be examined sequentially, thus an outlet count variable can be initialized (step 904). Of course, the invention should not be construed as being limited to sequential examination/evaluation of outlet current values.

A method 900 can continue by acquiring a current for a given outlet (step 906). Such a step can include any of the various methods noted above, and preferably includes capturing such a value in digital form.

A current value for a power distribution outlet may then be compared to a low limit (step 908). Such a step is preferably performed with software. If an outlet current value (IOUT) is above a low limit (ILOW), a low flag and low timer can be cleared (if not already cleared) (steps 910 and 912). If an outlet current value (IOUT) is below a low limit (ILOW), a low flag for the outlet can be examined (step 914).

If the outlet has not been previously flagged low, a low flag and low timer for the outlet can be set (steps 916 and 918). Setting a low timer can start a low grace period. If the outlet has been previously flagged low, the outlet is in a low grace period. A method 900 can then examine if the low grace period has expired (step 920). If a low grace period has expired, a method can take a predetermined action. In this case, such an action includes issuing a low warning (step 922). Of course, other actions could be taken.

In this way, separate power distribution outlets of the same PDU can be examined for a low current condition, and action taken when a low current condition exists.

A method 900 may then proceed to examine a selected outlet for a high current condition (step 924). Such a step is preferably performed with software. If an outlet current value (IOUT) is below a high limit (IHI), a high flag and high timer can be cleared (if not already cleared) (steps 926 and 928). If an outlet current value (IOUT) is above a high limit (IHI), a high flag for the outlet can be examined (step 924).

If the outlet has not been previously flagged high, a high flag and high timer for the outlet can be set (steps 931 and 932). Setting a high timer can start a high grace period. If, however, the outlet has been previously flagged high, the outlet is in a high grace period. A method 900 can then examine if the high grace period has expired (step 934). If a high grace period has expired, a method 900 can take a predetermined action. In this case, such an action includes tripping a circuit breaker for such an outlet (step 936). Of course, other actions could be taken, including a warning, for example.

In this way, separate power distribution outlets of the same PDU can be examined for a high current condition, and action taken when a high current condition exists.

A method 900 can further include incrementing timers 938. In this way, high and/or low grace periods can continue to run.

A method 900 may then continue cycling through examination of each outlet current by proceeding to a next outlet of the PDU, or returning to a first outlet of the PDU (steps, 940, 942 and 944).

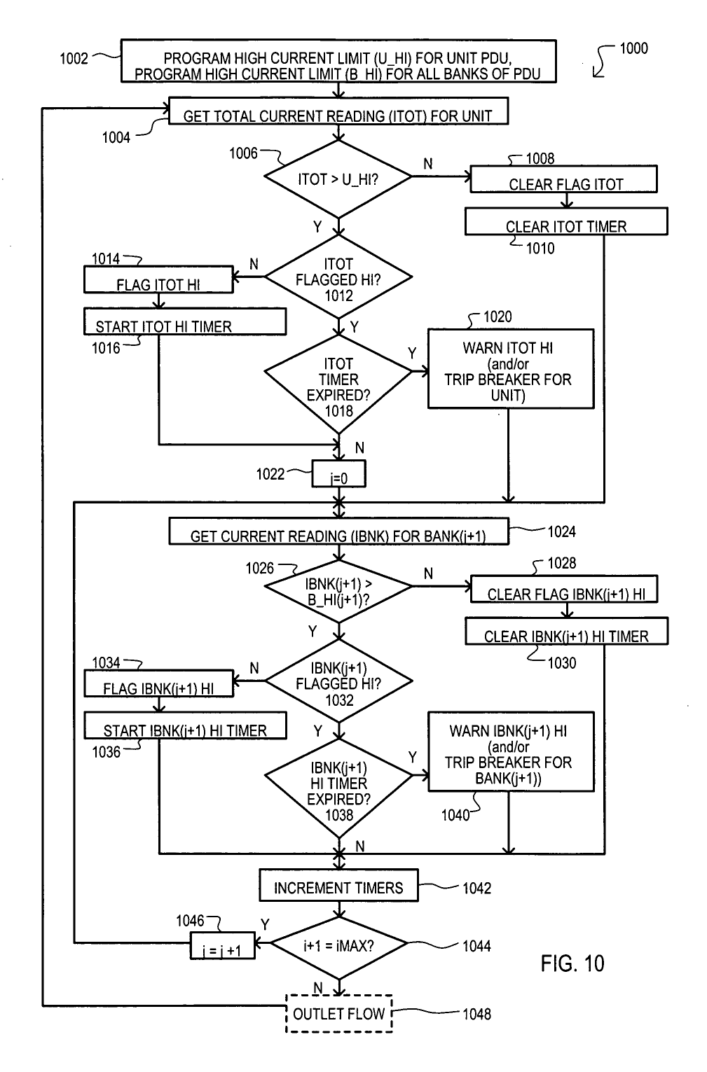

The present invention can include monitoring/controlling on a bank-by-bank or unit basis, in addition to an outlet-by-outlet basis. One example of such a method is shown in FIG. 10 and designated by the general reference character 1000. A method 1000 can include programming a high limit for a PDU and for all banks within a PDU (step 1002). As but one example, such a method can include programming a PDU by way of an interface, as described above.

In the very particular example of FIG. 10, a current value for an overall PDU (i.e., unit) may first be examined (step 1004). Thus, a method 1000 can continue by acquiring a total current for a PDU (step 1006). Such a step can include any of the various methods noted above (e.g., totaling individual outlet and/or bank values, or separately acquiring such a value). Preferably, a step 1006 includes capturing such a value in digital form.

A method 1000 may then continue in the same general fashion as method 900, but with respect to a unit current value. A current value may then be compared to a high current limit (step 1006). Such a step is preferably performed with software. If the total current value (ITOT) is lower than a high limit (U_Hi), a high flag and high timer can be cleared (if not already cleared (steps 1008 and 1010). If the total current value (ITOT) is lower than a high limit (U_Hi), a high flag can be examined (step 1012).

If the high flag had not been previously set high, the high flag and high timer for the bank or unit can be set (steps 1014 and 1016). Setting the high timer can start a high grace period. If the high flag has previously been set high, the power distribution bank or unit is already in a high grace period. A method 1000 may then examine whether the high grace period has expired (step 1018).

However, as shown by step 1020, in the event of a high current condition, a method 1000 may include issuing a warning in addition to, or instead of, tripping a breaker for a unit.

A method 1000 may then proceed by comparing bank current values to predetermined limits. In the very particular example of FIG. 10, current values for each separate bank may be examined sequentially (step 1024), thus a bank count variable can be initialized (step 1022). Of course, the invention should not be construed as being limited to sequential examination/evaluation of bank current values.

A method 1000 can continue by acquiring a total current for a bank (step 1026). Such a step can include any of the various methods noted above (e.g., totaling individual outlet values, or separately acquiring such a value). Preferably, a step 1026 includes capturing such a value in digital form.

A method 1000 may then continue in the same general fashion as method 900, but with respect to bank current values. In step 1028, the high bank flag and high bank timer may be cleared if the bank current does not exceed the high bank current in a comparison step (step 1026). However, if the comparison step (step 1026) indicates that the bank current exceeds the high bank current, then a check may be made to see if the particular bank has already been flagged high (step 1032). If the high bank current has not previously been set high, then steps 1034 and 1036, may set the high bank current and high bank timer. If the high bank timer had already been set high, a check may be made to see if the high bank timer has expired (step 1038).

If the high bank timer has expired, step 1040 may be performed. As shown by step 1040, in the event of a high current condition, a method 1000 may include issuing a warning in addition to, or instead of, tripping a breaker for a bank.

If the high bank timer has not expired, step 1042 increments the high bank timer. Method 1000 may continue cycling through information of each current bank by proceeding to a next bank of outlets in the PDU (steps 1044 and 1046). If the banks have been examined, the total PDU current may then be or individual outlets may be sampled again as the method 1000 may proceed to step 1048.

FIG. 10 also illustrates how an outlet comparison flow can be incorporated into a unit/bank comparison flow. Thus, box 1048 can include an outlet examination method, such as that shown in FIG. 9, as but one example.

An example of a software program function that may include the various features shown in FIGS. 9 and 10 is listed below. The software program may be stored in memory 238, as but one example.

Copyright © 2003-2004 by Cyber Switching Inc.
ALL RIGHTS RESERVED.
void OutletCurrentBoundTrapHandler(void)
{

auto unsigned int i;
auto char tonum[6];
auto char tcurrent[8]
auto char tsetcurrent[8]
auto float tfcurrent;
if(unitcurrenterrortraptimeout != 0)
{

if(gchk_timeout(unitcurrenterrortraptimeout))

unitcurrenterrortraptimeout = 0;

}
if(unitcurrentwarningtraptimeout != 0)
{

if(gchk_timeout(unitcurrentwarningtraptimeout))

unitcurrentwarningtraptimeout = 0;

}
tfcurrent = GetTotalCurrent( );
if(tfcurrent > UNIT_CURRENT_CAPACITY)
{

if(unitcurrenterrortraptimeout == 0)
{

sprintf(tcurrent,“%4.1f”,tfcurrent);
sprintf(tsetcurrent,“%4.1f”,BANK_CURRENT_{—}
CAPACITY);

AddLogEntry(LOGEVENT_ERRORUNITCURRENT,tcurrent,
tsetcurrent,NULL); //

Log high current violation.

TrapMyBitsUp(TRAP_UNITCURRENTCRITICAL,i);
unitcurrenterrortraptimeout = MS_TIMER+10000; // 10

seconds to next trap.

}

}
if(tfcurrent > UNIT_WARNING_CAPACITY)
{

if(unitcurrentwarningtraptimeout == 0)
{

sprintf(tcurrent,“%4.1f”,tfcurrent);
sprintf(tsetcurrent,“%4.1f”,BANK_CURRENT_{—}
CAPACITY);

AddLogEntry(LOGEVENT_WARNUNITCURRENT,tcurrent,
tsetcurrent,NULL); //

Log high current violation.

TrapMyBitsUp(TRAP_UNITCURRENTWARNING,i);
unitcurrentwarningtraptimeout = MS_TIMER+60000; // 60

seconds to next trap.

}

}
for(i = 0; i < NUM_BANKS; i++)
{

if(bankcurrenterrortraptimeout[i] != 0)
{

if(gchk_timeout(bankcurrenterrortraptimeout[i]))

bankcurrenterrortraptimeout[i] = 0;

}
if(bankcurrentwarningtraptimeout[i] != 0)
{

if(gchk_timeout(bankcurrentwarningtraptimeout[i]))

bankcurrentwarningtraptimeout[i] = 0;

}
tfcurrent = GetBankCurrent(i);
if(tfcurrent > BANK_CURRENT_CAPACITY)
{

if(bankcurrenterrortraptimeout[i] == 0)
{

sprintf(tonum,“%d”,i+1); // Bank Number
sprintf(tcurrent,“%4.1f”,tfcurrent);
sprintf(tsetcurrent,“%4.1f”,BANK_CURRENT_{—}
CAPACITY);

AddLogEntry(LOGEVENT_ERRORBANKCURRENT,tonum,
tcurrent,tsetcurrent);
// Log high current violation.

TrapMyBitsup(TRAP_BANKCURRENTCRITICAL,
i);
bankcurrenterrortraptimeout[i] = MS_TIMER+
10000; //

10 seconds to next trap.

}

}
else if(tfcurrent > BANK_WARNING_CAPACITY)
{

if(bankcurrentwarningtraptimeout[i] == 0)
{
sprintf(tonum,“%d”,i+1); // Bank Number
sprintf(tcurrent,“%4.1f”,tfcurrent);
sprintf(tsetcurrent,“%4.1f”,BANK_WARNING_{—}
CAPACITY);

AddLogEntry(LOGEVENT_WARNBANKCURRENT,tonum,
tcurrent,tsetcurrent); //

Log high current violation.

TrapMyBitsUp(TRAP_BANKCURRENTWARNING,
i);
bankcurrentwarningtraptimeout[i] = MS_TIMER+
60000;

// 60 seconds to next trap.

}

}

}
for(i = 0; i < MAX_OUTLET_NUM; i++)
{

if(boundtrapenables[i]&LOBOUNDTRAP_ENABLE)
{

if(GetOutletCurrent(i+1) < ocurrentlow[i])
{

if(boundtraplotimeouts[i] != 0)
{

if(gchk_timeout(boundtraplotimeouts[i]))
{

sprintf(tonum,“%d”,i+1);

sprintf(tcurrent,“%4.1f”,GetOutletCurrent(i+1));
sprintf(tsetcurrent,“%4.1f”,ocurrentlow[i]);
AddLogEntry(LOGEVENT_LOWCURRENT,tonum,tcurrent,
tsetcurrent); //

Log low current violation.

TrapMyBitsUp(TRAP_OUTLETLOWCURRENTWARNING,i);

boundtrapenables[i] |=

LOBOUNDTRAP_TRAPPED; // set trapped flag.

boundtraplotimeouts[i] = 0;

}

}
else if(!(boundtrapenables[i]&LOBOUNDTRAP_{—}
TRAPPED))
{

boundtraplotimeouts[i] =

MS_TIMER+boundtraplograce[i];

if(!boundtraplotimeouts[i])

boundtraplotimeouts[i]++;

}

}
else
{

boundtraplotimeouts[i] = 0;
boundtrapenables[i] &= ˜LOBOUNDTRAP_{—}
TRAPPED; //

Remove trapped flag.

}

}

if((boundtrapenables[i]&HIBOUNDTRAP_ENABLE)||

(boundtrapenables[i]&HIBOUNDTRIP_ENABLE))

{

if(GetOutletCurrent(i+1) > ocurrenthi[i])
{

if(boundtraphitimeouts[i] != 0)
{

if(gchk_timeout(boundtraphitimeouts[i]))
{

#ifdef PLUS_MODEL

if(boundtrapenables[i]&HIBOUNDTRIP_ENABLE)

SetOutletState(i+1,OS_TRIPPED);

#endif

sprintf(tonum,“%d”,i+1);

sprintf(tcurrent,“%4.1f”,GetOutletCurrent(i+1));
sprintf(tsetcurrent,“%4.1f”,ocurrenthi[i]);
AddLogEntry(LOGEVENT_HIGHCURRENT,tonum,tcurrent,
tsetcurrent); //

Log high current violation.

if(boundtrapenables[i]&HIBOUNDTRAP_ENABLE)
TrapMyBitsUp(TRAP_OUTLETHIGHCURRENTWARNING,i);

#ifdef PLUS_MODEL

if(boundtrapenables[i]&HIBOUNDTRIP_ENABLE)

{

TrapMyBitsUp(TRAP_OUTLETTRIPPED,i);
AddLogEntry(LOGEVENT_OUTLETTRIPPED,tonum,NULL,

NULL); // Log outlet trip.

}

#endif

boundtrapenables[i] |=

HIBOUNDTRAP_TRAPPED; // set trapped flag.

boundtraphitimeouts[i] = 0;

}

}
else if (!(boundtrapenables[i]&HIBOUNDTRAP_{—}
TRAPPED))
{

boundtraphitimeouts[i] =

MS_TIMER+boundtraphigrace[i];

if(!boundtraphitimeouts[i])

boundtraphitimeouts[i]++;

}

}
else
{

boundtraphitimeouts[i] = 0;
boundtrapenables[i] &= ˜HIBOUNDTRAP_{—}
TRAPPED; //

Remove trapped flag.

}

}

}

}

It is understood the above embodiments and portions thereof have been set forth in flow diagrams and a particular computer language, this should not be construed as limiting the invention thereto. One skilled in the art could arrive at alternate arrangements utilizing other programming language, including but not limited to all C variants (e.g., C++), Java, etc. and resulting compiled forms. Further, such embodiments may also comprise hardware design langauges, including but not limited to Verilog and VHDL.

In addition, it is understood that other embodiments of this invention may be practiced in the absence of an element/step not specifically disclosed herein. Thus, while methods have been illustrated that include a grace period for high and/or low events, alternate embodiments may not include such grace periods. Further, alternate embodiments may include multiple limits, some which include grace periods and others that do not.

While 8 load devices have been shown, any number of devices can be used in connection with this invention. Similarly, while a network 240 has been shown, computer 250 can communicate directly with one or more of: port 234, processing unit 236, and/or memory with software 238.

Accordingly, while the various particular embodiments set forth herein have been described in detail, the present invention could be subject to various changes, substitutions, and alterations without departing from the spirit and scope of the invention. Accordingly, the present invention is intended to be limited only as defined by the appended claims.

1. A current protection method, comprising the steps of:
sampling a current value of a current flowing from a power source to a load device for at least one current characteristic; and
interrupting the current flowing from the power source to the load device according to a comparison between the at least one current characteristic and at least one programmable limit.

2. The current protection method according to claim 1, wherein:
the at least one programmable limit is a predetermined current limit value.

3. The current protection method according to claim 1, wherein:
the at least one programmable limit is a predetermined time period and the current value exceeds a predetermined current limit value for essentially the predetermined time period.

4. The current protection method of claim 3, wherein:
the at least one programmable limit includes the predetermined current limit value.

5. The current protection method of claim 3, wherein:
the step of sampling a current value of a current flowing from a power source to a load device for at least one current characteristic is repeated a plurality of times during the predetermined time period.

6. The current protection method of claim 1, wherein:
the step of sampling a current value includes taking current readings of the current flowing from the power source to the load device and performing parametric calculations to provide the current value.

7. The current protection method of claim 4, wherein the current value is determined from performing parametric calculations from the group consisting of:
peak current, root mean square current, and crest factor harmonic current.

8. A current protection method for a power distribution unit, comprising the steps of:
sampling a first current value of a first current flowing from a first power distribution outlet to a first load device and a second current value of a second current flowing from a second power distribution outlet to a second load device;
comparing the first current value with a first predetermined current limit value and the second current value with a second predetermined current limit value; and
interrupting the first current flowing from the first power distribution outlet to the first load device in response to the first current value exceeding the first predetermined current limit value and interrupting the second current flowing from the second power distribution outlet to the second load device in response to the second current value exceeding the second predetermined current limit value.

9. The current protection method according to claim 8, wherein:
the first predetermined current limit value and the second predetermined current limit value are programmable.

10. The current protection method according to claim 8, wherein:
the step of comparing the first current value with a first predetermined current limit value and the second current value with a second predetermined current limit value is performed with software.

11. The current protection method according to claim 8, wherein:
when the step of comparing the first current value results in the first current value exceeding the first predetermined current limit value, repeating the step of sampling the first current value and the step of comparing the first current value with the first predetermined current limit value after a first predetermined time period and when the step of comparing the second current value results in the second current value exceeding the second predetermined current limit value, repeating the step of sampling the second current value and the step of comparing the second current value with the second predetermined current limit value after a second predetermined time period; and
interrupting the first current flowing from the first power distribution outlet only when the second step of comparing results in the first current value exceeding the first predetermined current limit value and interrupting the second current flowing from the second power distribution outlet only when the second step of comparing results in the second current value exceeding the second predetermined current limit value.

12. The current protection method according to claim 11, wherein:
the first predetermined time period and the second predetermined time period are the same.

13. The current protection method according to claim 11, wherein:
the first predetermined time period and the second predetermined time period are different.

14. The current protection method according to claim 11, wherein:
the step of comparing the first current value with the first predetermined current limit value after the first predetermined time period and the step of sampling the second current value and the step of comparing the second current value with the second predetermined current limit value after the second predetermined time period are performed with software.

15. A current protection method for a power distribution unit, comprising the steps of:
sampling a plurality of current values for a plurality of currents, each of the plurality of currents comprising a current flowing between one of a plurality of power distribution outlets and a corresponding load device;
comparing each of the plurality of current values with a corresponding one of a plurality of predetermined current limit values; and
interrupting the current flowing between the corresponding power distribution outlet and the corresponding load device if the corresponding current value is greater than the corresponding predetermined current limit value.

16. The current protection method for a power distribution unit of claim 15, wherein:
each of the plurality of predetermined current limit values is programmable.

17. The current protection method for a power distribution unit of claim 16, wherein:
the step of comparing each of the plurality of current values with the corresponding one of the plurality of predetermined current limit values is performed with software.

18. A current protection computer program embodied on computer readable media, comprising:
a reading code portion for reading a plurality of current values for a plurality of currents, each of the plurality of currents comprising a current flowing between one of a plurality of power distribution outlets and a corresponding load device; and
a comparing code portion for comparing each of the plurality of current values with a corresponding one of a plurality of predetermined current limit values and providing an interrupt command for interrupting the current flowing between the corresponding power distribution outlet and the corresponding load device if the corresponding current value is greater than the corresponding predetermined current limit value.

19. The current protection computer program embodied on computer readable media according to claim 18, wherein:
each one of the plurality of predetermined current limit values is programmable.

20. The current protection computer program embodied on computer readable media according to claim 18, wherein:
the reading code portion reads the plurality of current values during a predetermined time period; and
the comparing code portion provides the interrupt command if the corresponding current value is greater than the corresponding predetermined current value for essentially the predetermined time period.

21. The current protection computer program embodied on computer readable media according to claim 20, wherein:
the predetermined time period is programmable.
